(19) United States
(12) Patent Application Publication
(10) Pub. No.: US 2014/0081889 A1
(43) Pub. Date: Mar. 20, 2014

(54) Purifying Portfolios Using Orthogonal Non-Target Factor Constraints

(71) Applicant: Anthony A. Renshaw, New York, NY (US)

(72) Inventor: Anthony A. Renshaw, New York, NY (US)

(73) Assignee: AXIOMA, INC., New York, NY (US)

(21) Appl. No.: 14/025,127

(22) Filed: Sep. 12, 2013

Related U.S. Application Data
(60) Provisional application No. 61/700,962, filed on Sep. 14, 2012.

(51) Int. Cl. G06Q 40/06

(52) U.S. Cl. CPC G06Q 40/06
USPC 705/36 R

(57) ABSTRACT

The quantitative construction of investment portfolios of securities such as stocks, bonds, or the like using optimization is addressed. More specifically, during optimization constraints on non-target factor exposures are automatically converted to constraints on the exposure of the projections of the non-target factors that are orthogonal to a specified target factor. Such constraints may be utilized to produce portfolios with superior performance to those produced with traditional factor exposure constraints.

The present application claims the benefit of U.S. Provisional Application Ser. No. 61/700,962 entitled “Purifying Portfolios Using Orthogonal Non-Target Factor Constraints”, filed on Sep. 14, 2012 which is hereby incorporated by reference in its entirety.

### FIELD OF INVENTION

The present invention relates to methods for constructing investment portfolios designed to capture the behavior of one or more target factors. More particularly, it relates to improved computer based systems, methods and software for construction of factor portfolios using optimization by reducing the portfolio's exposure to non-target factors, commonly referred to as unintended bets.

### BACKGROUND OF THE INVENTION

In 2011, there was an explosion of ETFs offering a wide selection of affordable “factor” exposures, including the Russell-Axioma Factor ETFs and PowerShares ETFs. The factors selected—volatility, beta and momentum, among others—are a subset of the “style risk factors” used by commercial equity fundamental factor risk models for the past three decades, so these factors clearly explain risk. Several of these factors have been also closely associated with highly successful hedge funds, so the implication is that these factors are also potential alpha signals.

Factor ETFs come in two principal flavors: simple factor ETFs and purified factor ETFs. All factor ETFs have a strong exposure to the targeted factor. Simple factor ETFs do that and nothing more. In contrast, purified factor ETFs deliver not only the target factor exposure but also take steps to explicitly reduce the exposure of the ETF to non-target factors. This purifies the target signal and reduces unintended exposures that may inadvertently harm performance.

Non-target factor exposures are neutral when they have the same or similar exposures as an underlying benchmark. Large exposure over-weights or under-weights relative to a benchmark, normally referred to as active exposures, can either be intended or unintended. In a factor ETF or factor portfolio, a large exposure to the target factor is an intentional exposure. Any other exposures, however, are likely to be unintended.

Unintended bets in a portfolio are flaws. From the perspective of a factor risk model, unintended bets produce additional risk for the portfolio, and good portfolio managers should not unintentionally take on additional risk. Furthermore, in practice, unintended bets often reduce the return of the portfolio. As a general rule, it is desirable to reduce the absolute magnitude of any active exposures to non-target factors.

For portfolio managers, purified ETFs or portfolios can be easier to work with since they are less likely to inadvertently alter the exposure of a composite set of holdings. A portfolio manager who buys a low volatility ETF expects that holding to make his overall exposure to volatility lower. Normally, however, the portfolio manager would not want that purchase to significantly change his overall exposure to size, value or growth. If, however, there were unintended bets in size, value, or growth, then the portfolio manager would need to do additional work to manage those exposures.

Optimization techniques are frequently used to construct a portfolio of holdings for a universe or set of potential investment opportunities or assets. For example, the stocks comprising the Russell 1000 index represent a universe of US large cap stocks. The stocks comprising the Russell 2000 index represent a universe of US small cap stocks.

Optimization has a long history in portfolio construction, including the construction of purified factor portfolios. Mean-variance portfolio optimization was first described by H. Markowitz, “Portfolio Selection”, Journal of Finance 7(1), pp. 77-91, 1952 which is incorporated by reference herein in its entirety. In mean-variance optimization, a portfolio is constructed that minimizes the risk of the portfolio while achieving a minimum acceptable level of return. Alternatively, the level of return is maximized subject to a maximum allowable portfolio risk. The family of portfolio solutions solving these optimization problems for different values of either minimum acceptable return or maximum allowable risk is said to form an “efficient frontier”, which is often depicted graphically on a plot of risk versus return. There are numerous, well known, variations of mean-variance portfolio optimization that are used for portfolio construction. These variations include methods based on utility functions, Sharpe ratio, and value-at-risk.

In these optimizations, the expected return or alpha signal, if present, serves as the target factor in the optimization.

Portfolio construction using optimization techniques makes use of an estimate of portfolio risk, and some approaches make use of an estimate of portfolio return. A crucial issue for these optimization techniques is how sensitive the constructed portfolios are to changes in the estimates of risk and return. Small changes in the estimates of risk and return occur when these quantities are re-estimated at different time periods. They also occur when the raw data underlying the estimates is corrected or when the estimation method itself is modified. Mean-variance optimal portfolios are known to be sensitive to small changes in the estimated asset return, variances, and covariances. See, for example, J. D. Jobson, and B. Korkei, “Putting Markowitz Theory to Work”, Journal of Portfolio Management, Vol. 7, pp. 70-74, 1981 and R. O. Michaud, “The Markowitz Optimization Enigma: Is Optimized Optimal?”, Financial Analyst Journal, 1989, Vol. 45, pp. 31-42, 1989 and Efficient Asset Management: A Practical Guide to Stock Portfolio Optimization and Asset Allocation, Harvard Business School Press, 1998, (the two Michaud publications are hence referred to collectively as “Michaud”) all of which are incorporated by reference herein in their entirety.

A number of procedures have been proposed to alleviate the sensitivity of optimized portfolios to changes or errors in the input data. The most common approach is to add constraints to the optimization problem that restrict the range of possible portfolio holdings. For example, the minimum and maximum asset allocation may be limited to, say, zero and two percent of the total portfolio value respectively. Alternatively, the minimum and maximum exposure of the portfolio to an industry, industrial sector, or country may also be incorporated in the portfolio construction strategy.

Commercial equity factor risk models predict risk using a set of data factors that capture important characteristics of the possible investment opportunities. These factors can include industries and countries. They can also include other “style” factors such as value, growth, size, and volatility. In practice, it is common to constrain the net exposure of the portfolio to each of these style factors so that it is close to the exposure of a benchmark portfolio. Typically, the factor scores for style factors are reported as standardized scores or “Z scores” by taking the raw factor score and subtracting the aggregate score for the benchmark and then dividing this benchmark relative value by the standard deviation of the raw factor scores. Z scores report all style factors in a common dimensionless format that makes it easier to determine if a given exposure is large or small. See for example, R. Litterman, Modern Investment Management: An Equilibrium Approach, John Wiley and Sons, Inc., Hoboken, N.J., 2003 (Litter man), which is incorporated by reference herein in its entirety.

A factor mimicking portfolio is defined as a portfolio in which the net exposure of the portfolio to a single target factor is one and the net exposure of the portfolio to a set of non-target exposures is identically zero. See Litterman for details. By construction, factor mimicking portfolios have perfect purity. The returns of a factor mimicking portfolio can be taken to represent the return of that factor. Often, the set of non-target factors are the factors from a commercial factor risk model. Commercial risk model vendors spend considerable effort selecting the set of factors used by the model so that they represent a broad range of expected asset returns as accurately as possible.

As with the asset holdings, industry, sector, and country constraints, style constraints are linear bounds on the portfolio holdings which can be readily solved using modern computer optimization software. The ease of use and intuitive simplicity of these constraints account for their popularity. Indeed, virtually all commercial portfolio optimization software allows a portfolio manager to impose these kinds of constraints. For example, Axioma sells a portfolio optimization software under the name Axioma Portfolio™ software with this functionality. (Axioma Portfolio is a trademark of Axioma, Inc.).

A central concept used by the present invention is the decomposition of a non-target factor into one part that aligns with the target factor and a second part that is orthogonal or perpendicular to the target factor. As the overlap between the target and non-target factors increases, the magnitude of the aligned part increases.

FIG. 1 illustrates a simple example where a target factor overlaps with two non-target factors. A target factor 150 is illustrated as a horizontal vector pointing to the right. A first non-target factor 152 is illustrated by a vector pointing to the upper right side of FIG. 1. A second non-target factor 154 is shown by a vector pointing to the upper left of FIG. 1. The acute angle between the first non-target factor 152 and the target factor 150 is shown by the angle 156. The acute angle between the second non-target factor 154 and the target factor 150 is shown by the angle 158. Note that since acute angles must be between zero and ninety degrees, this angle is measured between the second target vector and the extension of the target vector extending to the left.

FIG. 2 illustrates how a first non-target factor 162 is decomposed into the sum of two different vectors, a vector 164 representing the projection of the first non-target factor onto the target factor 160 and a vector 166 representing the orthogonal projection of the first non-target factor with respect to the target factor. By construction, the aligned projection points in the same direction as the target factor while the orthogonal projection is perpendicular to the target factor.

FIG. 3 illustrates how a second non-target factor 172 is decomposed into the sum of two different vectors, a vector 174 representing the projection of the first non-target factor onto the target factor 170 and a vector 176 representing the orthogonal projection of the first non-target factor with respect to the target factor. In this example, the aligned projection points in the opposite direction as the target factor which, of course, is still aligned with the target factor while the orthogonal projection is perpendicular to the target factor.

As the number of factors considered increases, it becomes more likely for there to be overlap between factors. To be sure, factors can be mathematically constructed so that they have no overlap. However, many intuitive and commonly used factors naturally have significant overlap. For example, Axioma's US Fundamental Factor Risk Model currently uses ten style factors and sixty eight industry factors. Historically, several of the factors have overlapped significantly.

FIG. 4 shows the historical overlap between two pairs of factors in Axioma's US Fundamental Factor Risk Model for a large cap benchmark of about 1000 stocks. The overlap is measured by plotting the acute angle between two factors. The smaller the acute angle, the more overlap there is between the two factors. If the two factors are orthogonal, then the acute angle is ninety degrees. FIG. 4 plots the acute angle between the market sensitivity factor and the volatility factor 200 and the acute angle between the size factor and the volatility factor 202 from 1987 to 2012. For virtually the entire time period, the angle for market sensitivity vs. volatility is smaller than the angle for size vs. volatility. Whereas the angle for size is 50 degrees at its smallest in early 2009, the angle for market sensitivity is often less than 40 degrees.

Since smaller angles mean more overlap, this means that there is significant overlap between Axioma's market sensitivity factor and its volatility factor.

The problem addressed by the current invention occurs when there is significant overlap between a target factor and a non-target factor used to purify the target portfolio. By construction, the exposure to the target factor is large. Hence, the exposure to an overlapping non-target factor is at least as large as the overlapping, aligned part of the non-target factor. Even if the optimization attempts to minimize or constrain the overlapping non-target factor to be as neutral (e.g., close to zero) as possible, its magnitude cannot be less than that derived from the overlapping part of it. In this case, the mutual goals of having a large target factor exposure and purifying (e.g., neutral or small absolute) non-target exposures are antagonistic.

For example, it is well known that volatility factors, which use some measure of historic asset volatility, and beta or market sensitivity factors, which use a measure of the historical correlation between an asset's return and a benchmark's return, have significant overlap. The beta of an asset is the covariance of the asset's return with those of a benchmark divided by the variance of the benchmark's return. By construction, the beta of a benchmark is one. One expects the beta of a low volatility portfolio to be significantly less than one; typical values would be 0.6 or 0.7. In other words, a low volatility portfolio generally cannot be neutral to beta since that would require its beta to be close to 1.0.

### SUMMARY OF THE INVENTION

The present invention recognizes that current portfolio optimization software does not automatically adjust exposure constraints according to whether or not there is significant overlap between the factor being constrained and the desired target factor tilts that are to be either maximized or minimized.

One goal of the present invention, then, is to describe a methodology that will automatically adjust any exposure constraint based on the degree of overlap between it and one or more target factors.

Another goal is to describe an improved method for constructing purified portfolios; that is, portfolios with a large target factor exposure but limited or constrained non-target exposures.

Another goal of the present invention is to provide an easy way for investors to historically simulate the performance of the automatically adjusted exposure constraints through a backtest.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a simple example of a target factor and two non-target factors;

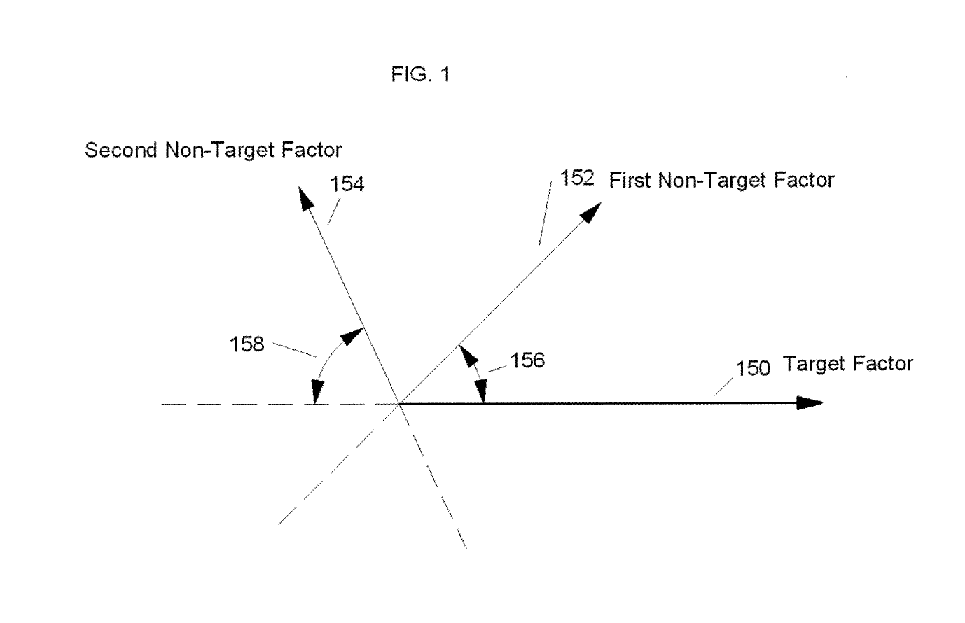

FIG. 2 illustrates a first non-target factor being decomposed into an aligned component and orthogonal component;

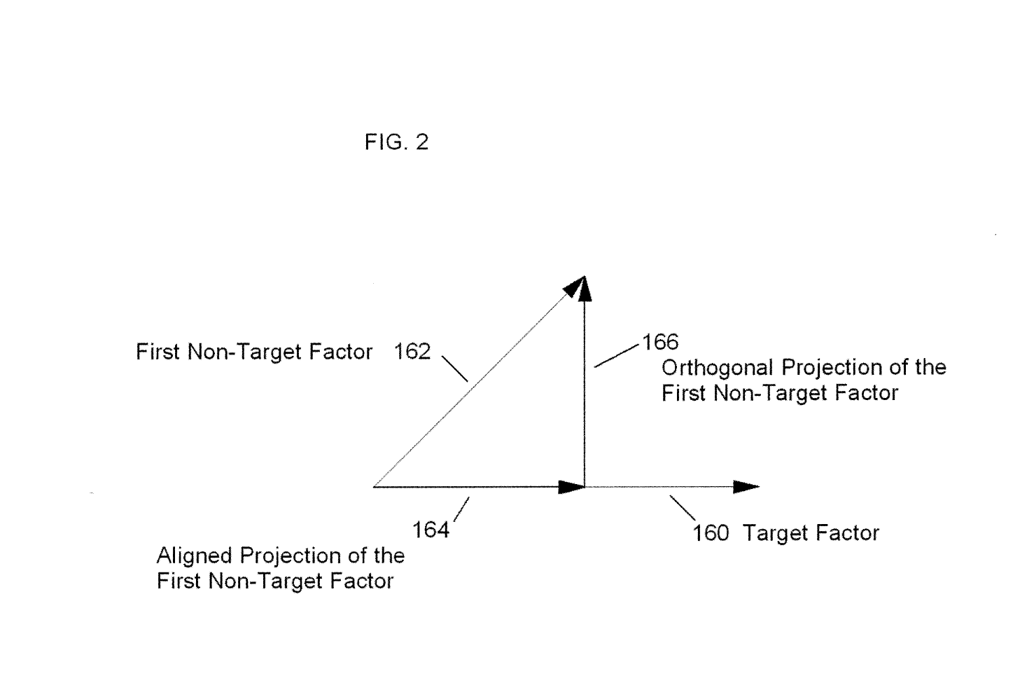

FIG. 3 illustrates a second non-target factor being decomposed into an aligned component and orthogonal component;

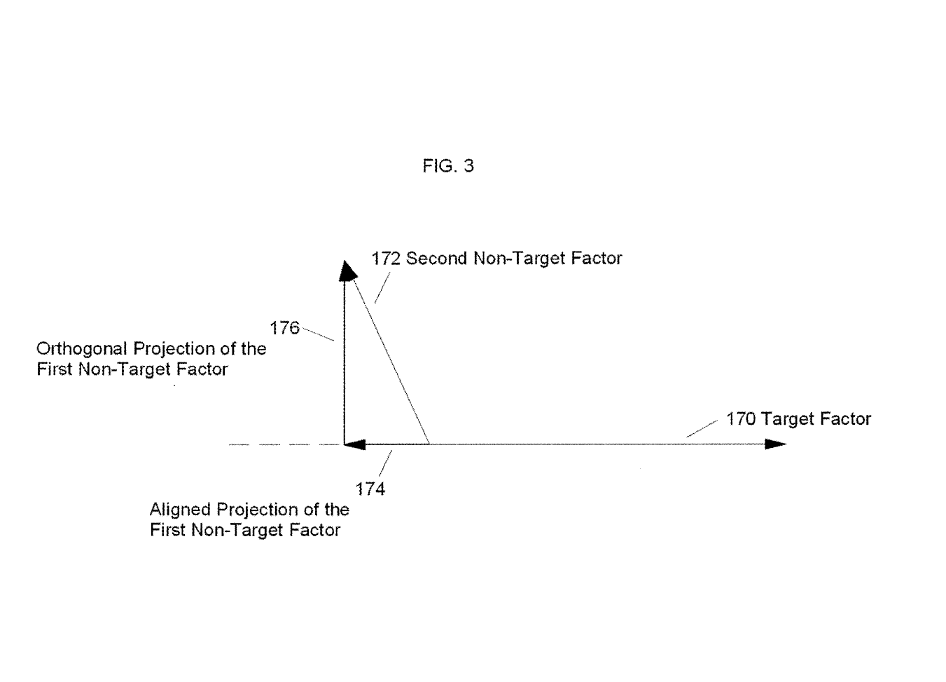

FIG. 4 illustrates the historical overlap of two pairs of factors in Axioma's US Fundamental Factor Equity risk model from 1987 to 2012;

FIG. 5 shows a computer based system which may be suitably utilized to implement the present invention;

FIG. 6 shows performance statistics for four portfolios from a backtest using US equities from Jun. 30, 2009 and Aug. 31, 2012;

FIG. 7 shows the cumulative returns for four portfolios from a backtest using US equities from Jun. 30, 2009 and Aug. 31, 2012;

FIG. 8 shows the exposure to the volatility factor for three low volatility portfolios from a backtest using US equities from Jun. 30, 2009 and Aug. 31, 2012;

FIG. 9 shows the exposure to the size factor for three low volatility portfolios from a backtest using US equities from Jun. 30, 2009 and Aug. 31, 2012;

FIG. 10 shows the exposure to the market sensitivity factor for three low volatility portfolios from a backtest using US equities from Jun. 30, 2009 and Aug. 31, 2012;

FIG. 11 shows performance statistics for four portfolios from a backtest using European equities from Apr. 30, 2004 and Aug. 31, 2012;

FIG. 12 shows the cumulative returns for four portfolios from a backtest using European equities from Apr. 30, 2004 and Aug. 31, 2012;

FIG. 13 shows the exposure to the volatility factor for three low volatility portfolios from a backtest using European equities from Apr. 30, 2004 and Aug. 31, 2012;

FIG. 14 shows the exposure to the size factor for three low volatility portfolios from a backtest using European equities from Apr. 30, 2004 and Aug. 31, 2012;

FIG. 15 illustrates a simple schematic of a target factor and one non-target factor;

FIG. 16 illustrates the orthogonal non-target factor and the orthogonal alpha for the schematic of FIG. 15;

FIG. 17 illustrates the orthogonal non-target factor, the orthogonal alpha, and orthogonal holdings for the schematic of FIG. 15;

FIG. 18 illustrates benchmark weights, realized returns, and expected returns (“alpha”) for a simple numerical example of the invention using a universe of eight assets;

FIG. 19 illustrates factor risk model matrices including the matrix of factor exposures, the factor-factor covariance matrix, and the vector or specific risks for the simple numerical example of the invention using a universe of eight assets;

FIG. 20 illustrates exposures to non-target factors “Factor1” and “Factor2” and the exposures of these two factors that are orthogonal to the target factor “alpha” for the simple numerical example of the invention using a universe of eight assets;

FIG. 21 illustrates vectors of relative wealth allocations for four portfolios including the benchmark, an optimal portfolio with no constraints on the exposures to Factor1 and Factor2, an optimal portfolio with the active exposures relative to the benchmark to Factor1 and Factor2 limited to plus and minus ten percent, and an optimal portfolio with the active exposures relative to the benchmark to orthogonal Factor1 and orthogonal Factor2 limited to plus and minus ten percent for the simple numerical example of the invention using a universe of eight assets; and

FIG. 22 illustrates performance statistics for the four portfolios shown in FIG. 22.

### DETAILED DESCRIPTION

The present invention may be suitably implemented as a computer based system, in computer software which is stored in a non-transitory manner and which may suitably reside on computer readable media, such as solid state storage devices, such as RAM, ROM, or the like, magnetic storage devices such as a hard disk or solid state drive, optical storage devices, such as CD-ROM, CD-RW, DVD, Blue Ray Disc or the like, or as methods implemented by such systems and software. The present invention may be implemented on personal computers, workstations, computer servers or mobile devices such as cell phones, tablets, IPads™, IPods™ and the like.

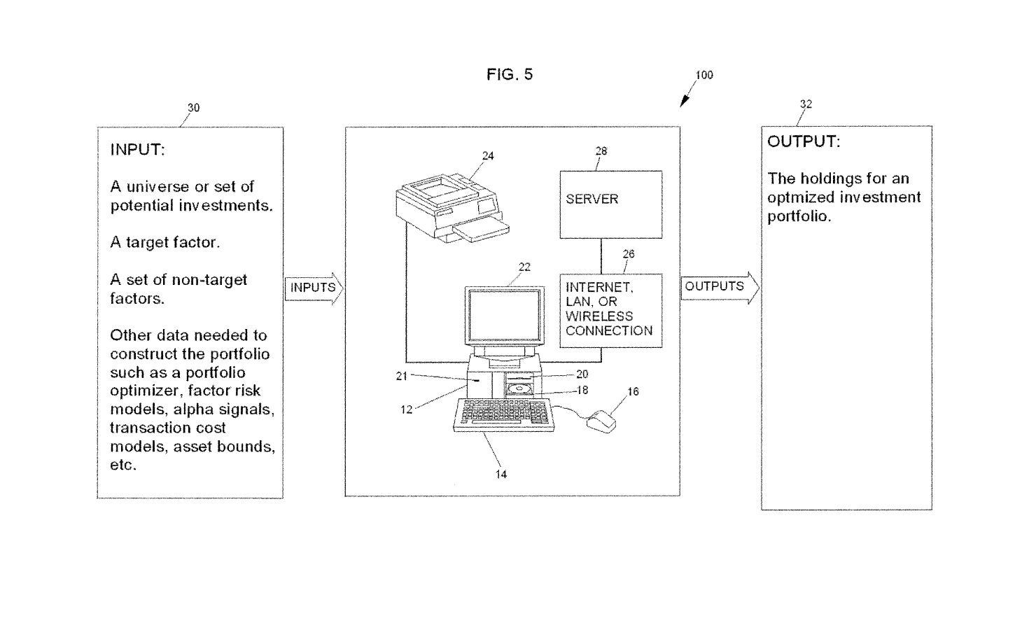

FIG. 5 shows a block diagram of a computer system 100 which may be suitably used to implement the present invention. System 100 is implemented as a computer or mobile device 12 including one or more programmed processors, such as a personal computer, workstation, or server. One likely scenario is that the system of the invention will be implemented as a personal computer or workstation which connects to a server 28 or other computer through an Internet, local area network (LAN) or wireless connection 26. In this embodiment, both the computer or mobile device 12 and server 28 run software that when executed enables the user to input instructions and calculations on the computer or mobile device 12, send the input for conversion to output at the server 28, and then display the output on a display, such as display 22, or print the output, using a printer, such as printer 24, connected to the computer or mobile device 12. The output could also be sent electronically through the Internet, LAN, or wireless connection 26. In another embodiment of the invention, the entire software is installed and runs on the computer or mobile device 12, and the Internet connection 26 and server 28 are not needed. As shown in FIG. 5 and described in further detail below, the system 100 includes software that is run by the central processing unit of the computer or mobile device 12. The computer or mobile device 12 may suitably include a number of standard input and output devices, including a keyboard 14, a mouse 16, CD-ROM/CD-RW/DVD drive 18, disk drive or solid state drive 20, monitor 22, and printer 24. The computer or mobile device 12 also has a USB connection 21 which allows external hard drives, flash drives and other devices to be connected to the computer or mobile device 12 and used when utilizing the invention. It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as cell phones, tablets and e-readers such as an IPad™, IPhone™, IPod™, Blackberry™, Treo™, or the like.

One embodiment of the invention has been designed for use on a stand-alone personal computer running in Windows 7. Another embodiment of the invention has been designed to run on a Linux-based server system.

According to one aspect of the invention, it is contemplated that the computer or mobile device 12 will be operated by a user in an office, business, trading floor, classroom, or home setting.

As illustrated in FIG. 5, and as described in greater detail below, the inputs 30 may suitably include a universe or set of potential investments, a target factor, a set of non-target factors, as well as other data needed to construct the portfolio such as portfolio optimization software, factor risk models, alpha signals, transaction cost models, asset bounds, etc.

As further illustrated in FIG. 5, and as described in greater detail below, the system outputs 32 may suitably include the holdings for an optimized investment portfolio.

The output information may appear on a display screen of the monitor 22 or may also be printed out at the printer 24. The output information may also be electronically sent to an intermediary for interpretation. For example, risk predictions for many portfolios can be aggregated for multiple portfolio or cross-portfolio risk management. Or, alternatively, trades based, in part, on the factor risk model predictions, may be sent to an electronic trading platform. Other devices and techniques may be used to provide outputs, as desired.

With this background in mind, we turn to a detailed discussion of the invention and its context. Suppose that there are N assets in an investment portfolio, and the weight or fraction of the available wealth invested in each asset is given by the N-dimensional column vector w. These weights may be the actual fraction of wealth invested or they may represent the difference in weights between a managed portfolio and a benchmark portfolio as described by Litterman. In this case, w=wₚ−w_{b} where wₚ is an N-dimensional column vector representing the fraction of wealth invested by the investor and w_{b} is an N-dimensional column vector representing the fraction of wealth invested in the benchmark or reference portfolio.

Suppose further that there is a target factor which is an N-dimensional column factor f and a matrix of M non-target factors given by the columns of the N×M dimensional matrix B. The target factor may be a vector of expected asset returns, which is sometimes called “alpha” and denoted with the Greek letter a. Alternatively, the target factor f may an N-dimensional column vector of factor scores. In a typical optimization problem, an optimal allocation of wealth is determined that either maximizes or minimizes the portfolio's exposure to f. That is, the product vector inner product w^{T} f is either as large or as small as possible.

The overlap problem occurs when the matrix-vector product of the transpose of B and f is non-zero.

Non-Orthogonality [symbol] B^{T}f≠0 (1)

If f is orthogonal to each column of B, then this matrix product returns an M dimensional vector of zeros.

In existing portfolio optimization software, one is allowed to impose minimum and maximum constraints on the exposures of the final, optimized portfolio to each of the M factors. That is, in existing portfolio optimization software, the functionality exists to impose

L≦B^{T}w≦U (2)

Here, L is an M-dimensional vector of lower bounds for the exposures of the portfolio and U is an M-dimensional vector of upper bounds for the exposures. If some of the constraints are unbounded, then the corresponding elements of L and U can be represented by minus infinity and plus infinity respectively. Since constraints with infinite bounds are automatically satisfied, high quality portfolio optimization software will omit such bounds and constraints when constructing the optimal portfolio.

In the present invention, we propose an alternative to this common type of constraint. Rather than constrain the exposure of the portfolio to the original factors, we constrain the exposure of the portfolio to that part of the original factors that is orthogonal to the target factor. That is, we first form a set of orthogonal non-target factors. For each of the M columns of B, we replace that column with its orthogonal projection. That is,

$${B}_{( j )}^{′} = {B}_{( j )} - ( \frac{{f}^{T} {B}_{( j )}}{{f}^{T} f} ) f , \\ j = 1 , … , M \qquad ( 3 )$$

where B₍ⱼ₎ is the j-th column of the original matrix B. We assemble the orthogonal matrix of non-target factors, B′, by putting the columns together, and then replace equation (2) with

L≦B′^{T}w≦U (4)

The optimal portfolio returned by the optimization depends on the manner in which the original target factor and non-target factors are normalized. In the results reported below, each of the factors is a Z score.

In one embodiment of the invention, we set L and U to be a vector of zeros and impose the constraints as soft constraints with a linear penalty functions. The vanishing L and U drive the solution to be as neutral as possible, while the soft constraint simply penalizes any deviation from perfect neutrality. The only parameters needed are therefore the magnitude of the linear penalty. In the approach described here, it was found that a non-zero penalty magnitude usually improves portfolio performance. The constraints (4) could also be implemented with a quadratic penalty, or imposed as hard constraints. Alternatively, the constraints could also be inserted into Axioma's Constraint Hierarchy tool, a tool that automatically softens hard constraints whenever infeasibilities are found.

Mathematicians will recognize a similarity between equation (3) and Gram-Schmidt orthogonalization. If there were more than one target factor for a portfolio, we can extend the orthogonalization process to include these different target factors. If there are K target factors, the K target factors can be processed as the first K vectors using the Gram-Schmidt method. Then, each of the M non-target factors would be modified using the formula for the (K+1)-th vector in the Gram-Schmidt method. Alternatively, one can construct a matrix P that will project any vector into the null space of a set of one or more target factors. Each constraint would then be modified by pre-multiplying by the matrix P.

In some situations, it may be practical to nearly orthogonalize the constraints, so that each constraint is nearly but not exactly orthogonal. In this case, the acute angle between the approximately orthogonalized constraints and the target factor would be close to ninety degrees but not exactly ninety degrees. One way to do that would be to replace equation (3) with

$${B}_{( j )}^{′} = {B}_{( j )} - ( 1 - {ɛ}_{j} ) ( \frac{{f}^{T} {B}_{( j )}}{{f}^{T} f} ) f , \\ j = 1 , … , M \qquad ( 5 )$$

where εⱼ is a small positive constant; that is, 0<εⱼ<<1. For the present invention, we use the terms orthogonalized and nearly orthogonalized interchangeably.

We now illustrate the use of the orthogonal non-target factor constraints using two backtests, a backtest using US equities and a backtest using European equities. In both backtests, the target factor is the volatility factor of Axioma's Fundamental Factor, Medium Horizon, Equity Risk Model. Axioma's US Fundamental Factor, Medium Horizon Equity Risk Model was used for the backtest with US equities, and Axioma's European Fundamental Factor, Medium Horizon Equity Risk Model was used for the backtest with European equities.

In each backtest, we minimize the exposure of the optimal portfolio to the volatility factor. The final active exposure is large and negative, indicating a low volatility exposure. Since we are targeting low volatility, the portfolios we are constructing will be less volatile than the underlying benchmarks.

In each backtest, we construct four portfolios each month. First, we construct a benchmark portfolio consisting of a market capitalization weighting of all assets in the investment universe. For the US backtest, we construct a large cap benchmark of approximately 1000 stocks. For the European backtest, we construct a large cap benchmark of approximately 1500 stocks.

Second, we construct a reference portfolio constructed by equi-weighting the 10% of the names in the universe with the lowest volatility score.

Third, we construct a traditional optimized portfolio which holds the same names as the reference portfolio but whose weights have been adjusted by optimization. The optimization objective minimizes the tracking error (e.g., active risk) between this optimized portfolio and the reference portfolio as predicted by the factor risk model. For this optimization, we purify the portfolio to non-target factors without any orthogonalization. The non-target factors are the style risk factors in the corresponding Axioma factor risk model, including the volatility factor. For each style factor, we impose benchmark neutral exposure (maximum exposure equals minimum exposure equals zero) as a soft constraint with a linear penalty for any positive or negative deviation from neutrality. Volatility is, of course, one of the factors in the style factors. In order to keep the target factor exposure strong, we constrain the target tilt of the optimized portfolio to be at least as low (e.g., large and negative) as the reference portfolio. Low volatility Z scores are negative, so the lower or more negative the exposure, the stronger the target tilt. The minimum and maximum holdings in any individual asset are zero and two percent of the total portfolio value.

Fourth, we construct an optimized portfolio identical to the traditional optimized portfolio but we impose non-target exposure constraints using the risk model style factors after they have been orthogonalized with respect to the volatility factor. Otherwise, the optimization is the same.

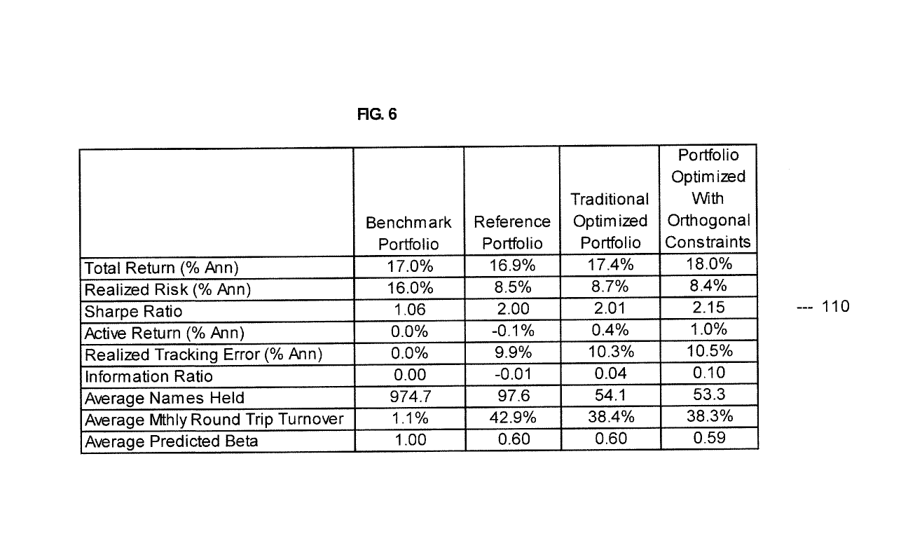

FIG. 6 shows the performance results 110 for the US backtest, which was rebalanced monthly between Jun. 30, 2009 and Aug. 31, 2012 using a universe of approximately 1000 large cap US equities.

For this set of backtests, we see that the best total return was obtained using the orthogonal style constraints. This case also had the highest Sharpe ratio and Information ratios. The optimized portfolios have somewhat lower turnover than the reference portfolio. By construction, the optimized portfolios can only hold at most the same names as the reference portfolio. In this case, the optimized portfolios hold about half the number of names as the reference portfolio. The predicted beta for the reference and optimized portfolios are virtually identical and well below one, as one would expect from a low volatility portfolio.

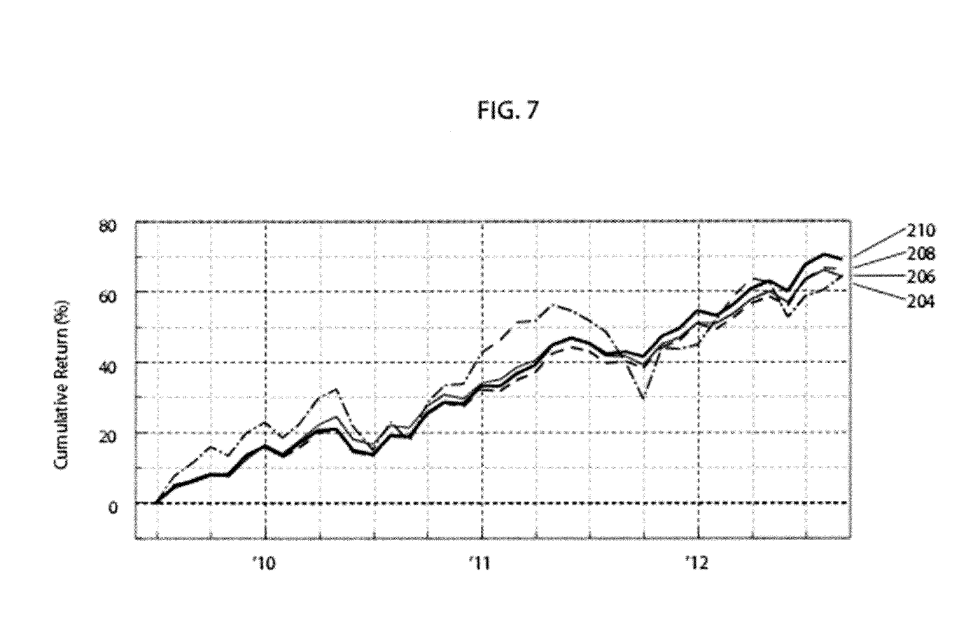

FIG. 7 compares the cumulative return of all four portfolios: the return of the benchmark 204 shown as a dashed-dotted line; the return of the reference portfolio 206 shown as a thin solid line; the return of the optimized portfolio with traditional constraints 208 shown as a dashed line; and the return of the portfolio optimized with orthogonal constraints 210 shown as a thick solid line.

The three low volatility portfolios have noticeably less volatility than the benchmark. Since mid-2011, the return of the portfolio optimized with orthogonal constraints has steadily outperformed the other three portfolios.

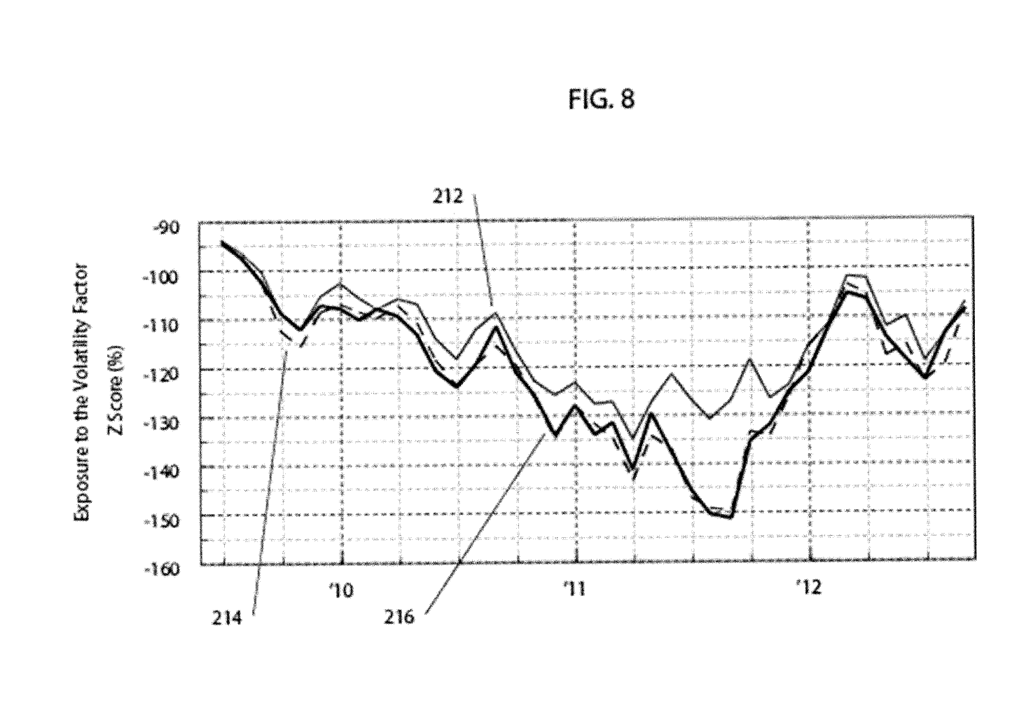

FIG. 8 shows the exposure of the three low volatility portfolios to the target factor, the volatility factor of the factor risk model: the exposure of the reference portfolio 212 shown by the thin solid line; the exposure of the traditional optimization 214 shown by the dashed line; and the exposure for the orthogonal optimization 216 shown by the thick solid line. The exposures of the optimized portfolios are at least as strongly negative as the reference portfolio, as imposed by the optimization.

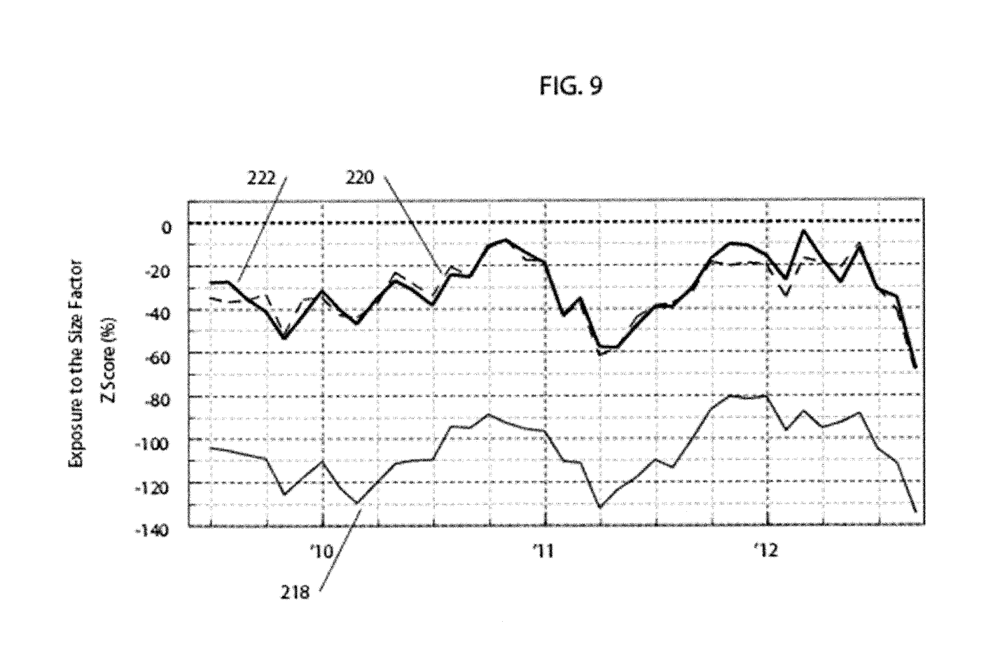

FIG. 9 shows the exposure of the three low volatility portfolios to the size factor. The size factor in a factor risk model is a Z score value representing the natural logarithm of the market capitalization of all assets in the benchmark. The non-target exposure constraints in both optimizations have dramatically altered the size factor exposure. Whereas the exposure of the reference portfolio 218 is about −100% (a substantial small cap bias representing a non-pure exposure relative to volatility), the exposure of the two optimized portfolios—220 for the traditional optimization and 222 for the constrained optimization—is about −40%. In other words, both the traditional constraints and the orthogonal constraints have neutralized or purified the size exposure by roughly 60%. The substantial small cap bias embedded in the reference portfolio has been dramatically corrected by both constraints.

In FIG. 9, the size exposure of the two optimized portfolio is approximately the same. Usually, there is less than a five percent difference in their size exposures. This indicates that the overlap between size and volatility is relatively small, e.g., the acute angle between the target factor (volatility) and the non-target factor (size) is large.

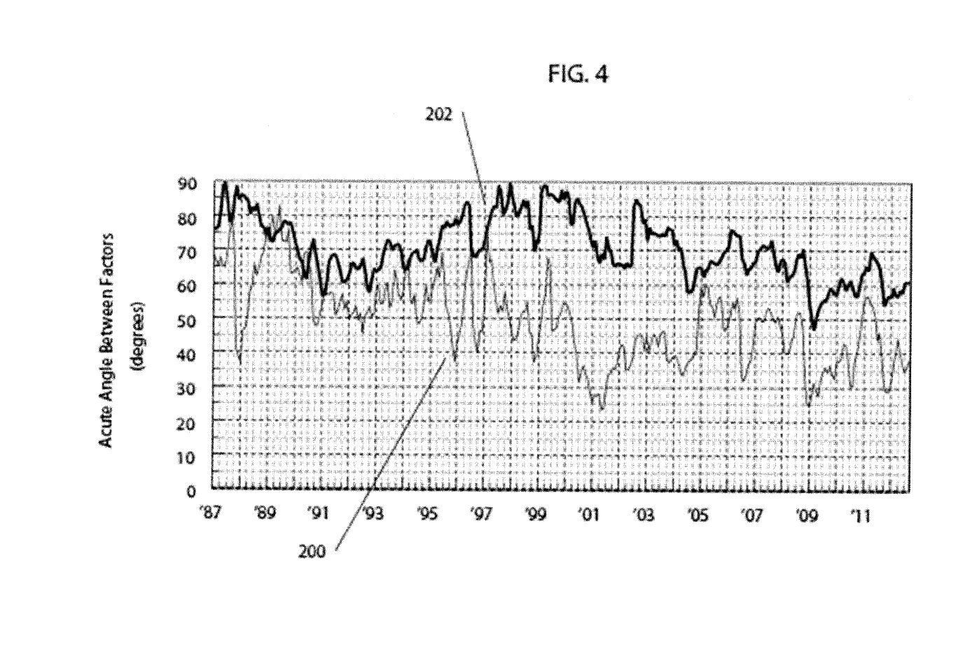

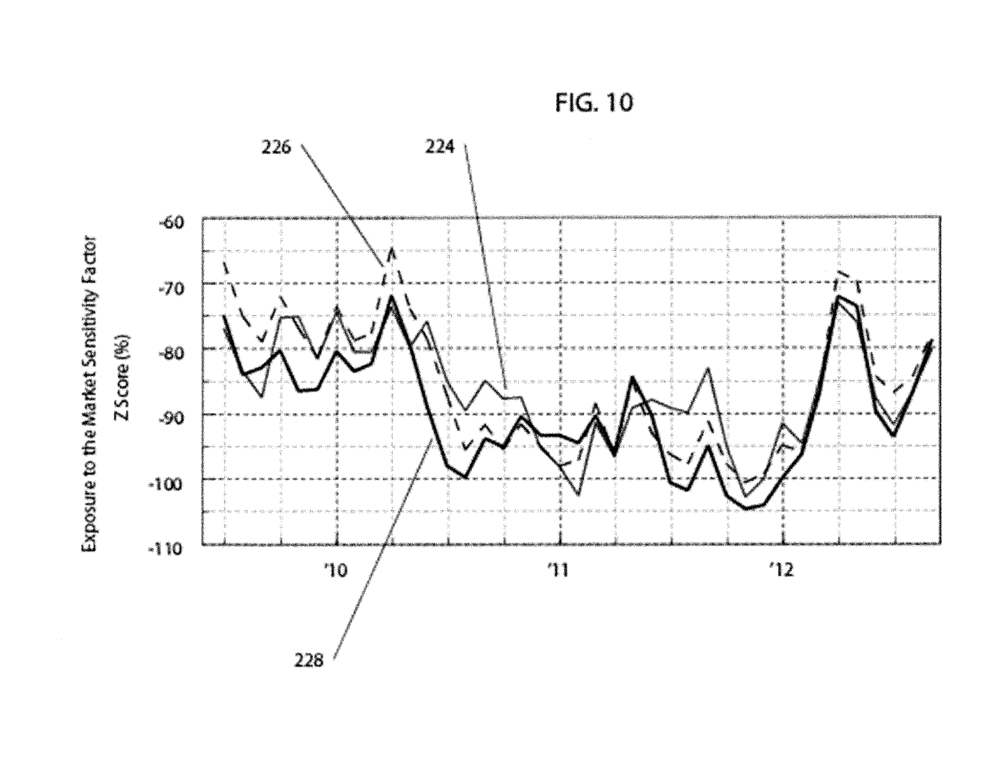

FIG. 10 shows the exposure of the three low volatility portfolios to the market sensitivity factor from the factor risk model. As shown in FIG. 4, there is more overlap between the market sensitivity factor and the volatility factor than there is for the size factor and the volatility factor. In other words, the acute angle between the volatility factor and the market sensitivity factor is smaller than the acute angle between the volatility factor and the size factor. As a consequence, we do not expect there to be a large difference between the reference and optimized portfolios. The market sensitivity factor exposure of the reference portfolio 224 is shown by the thin solid line, the portfolio with traditional optimization 226 is shown by the dashed line, and the portfolio with orthogonal optimization 228 is shown by the thick solid line. Usually, the three exposures arc within 10% to 20% of each other. However, as expected, the portfolio with orthogonal constraints often has less exposure to market sensitivity than the other two portfolios. In this case, constraining only the orthogonal component of the factor permits a much deeper exposure to the aligned part of the factor. This is the difference that purifies the holdings from unintended bets and enables the orthogonal constraints backtest to outperform the reference portfolio and the traditional optimization backtest.

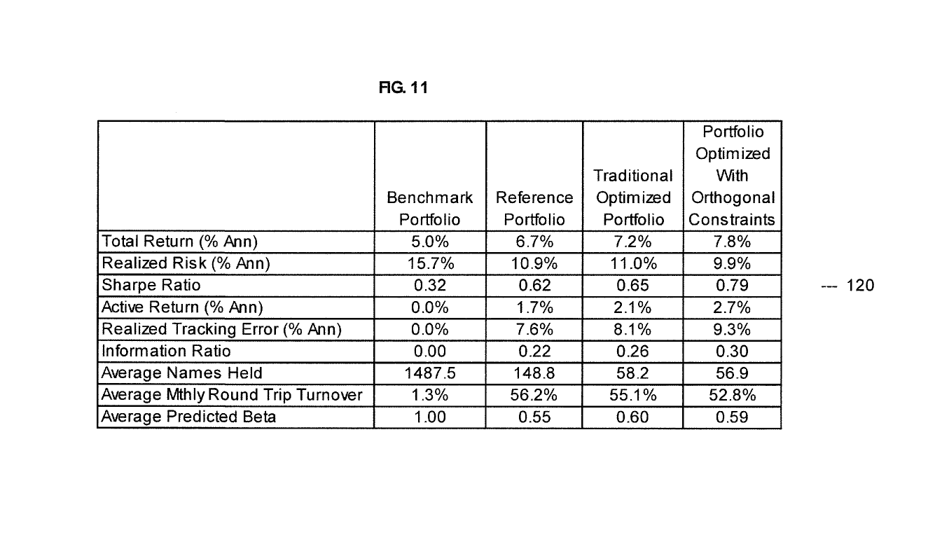

FIG. 11 shows the performance results 120 for the European backtest, which was rebalanced monthly between Apr. 30, 2004 and Aug. 31, 2012 using a universe of approximately 1500 large cap European equities.

For this set of longer backtests, the best total return was once again obtained using the orthogonal non-target factor constraints. This case also had the highest Sharpe ratio and Information ratios. The optimized portfolios have somewhat lower turnover than the reference portfolio. The optimized portfolios hold about two fifths as many names as the reference portfolio. The predicted beta for the reference and optimized portfolios are virtually identical and well below one.

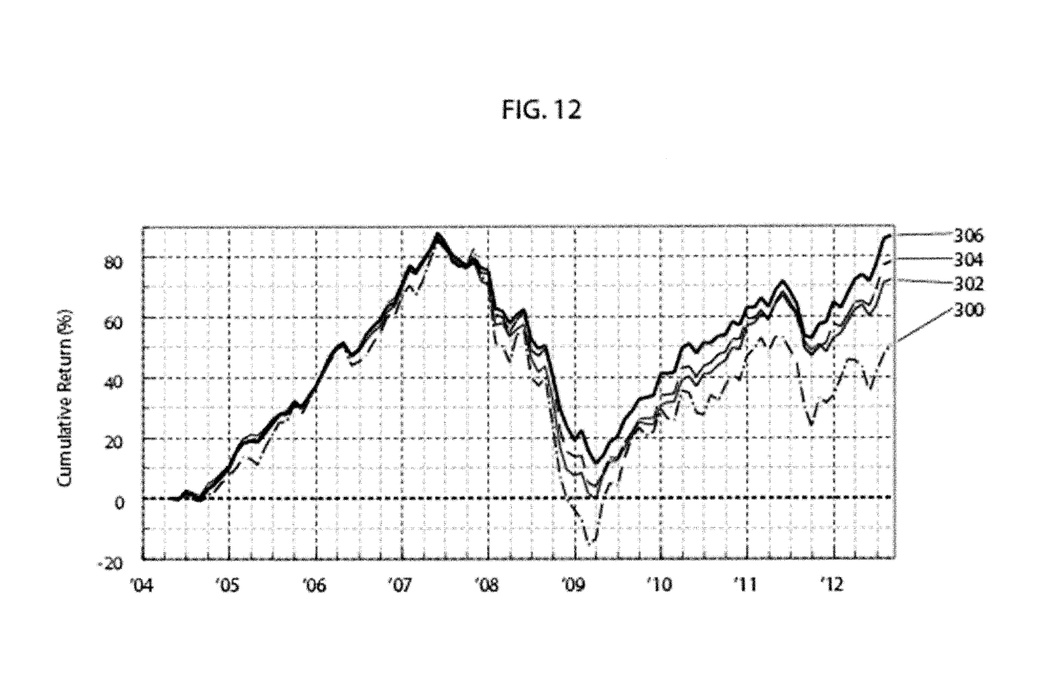

FIG. 12 compares the cumulative return of all four portfolios: the return of the benchmark 300 shown as a dashed-dotted line; the return of the reference portfolio 302 shown as a thin solid line; the return of the optimized portfolio with traditional constraints 304 shown as a dashed line; and the return of the portfolio optimized with orthogonal constraints 306 shown as a thick solid line.

FIG. 11 and FIG. 12 illustrate that the return of the portfolio optimized with orthogonal constraints steadily outperformed the other three portfolios. This illustrates that portfolios purified by imposing orthogonal non-target factor constraints can improve portfolio performance.

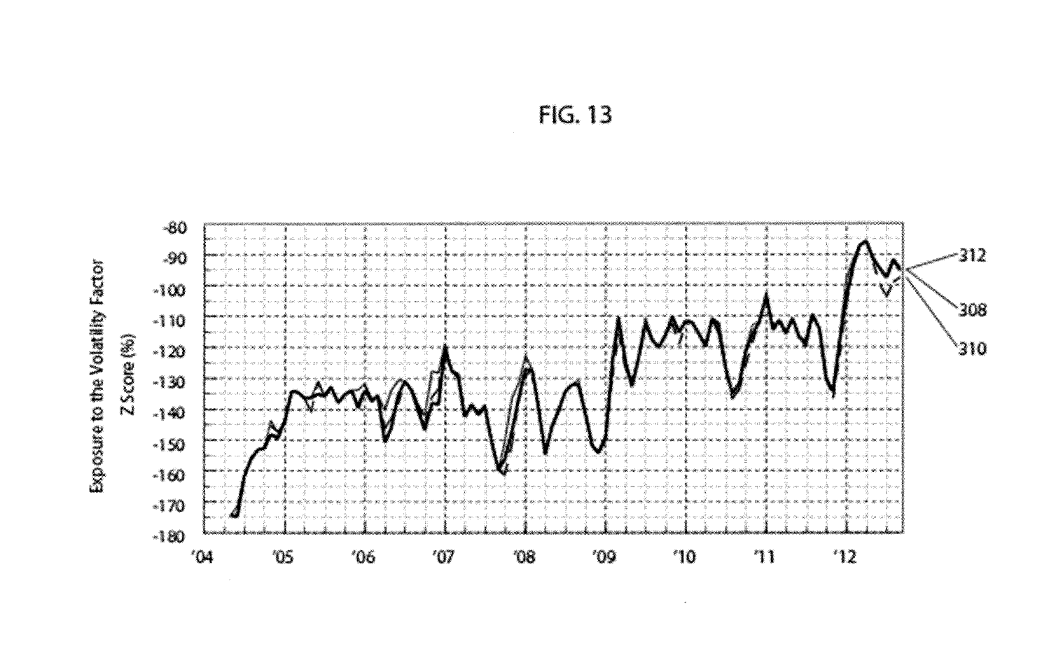

FIG. 13 shows the exposure of the three low volatility portfolios to the target factor, the volatility factor of the factor risk model: the exposure of the reference portfolio 308 shown by the thin solid line; the exposure of the traditional optimization 310 shown by the dashed line; and the exposure for the orthogonal optimization 312 shown by the thick solid line. The volatility exposures of all three portfolios are virtually identical.

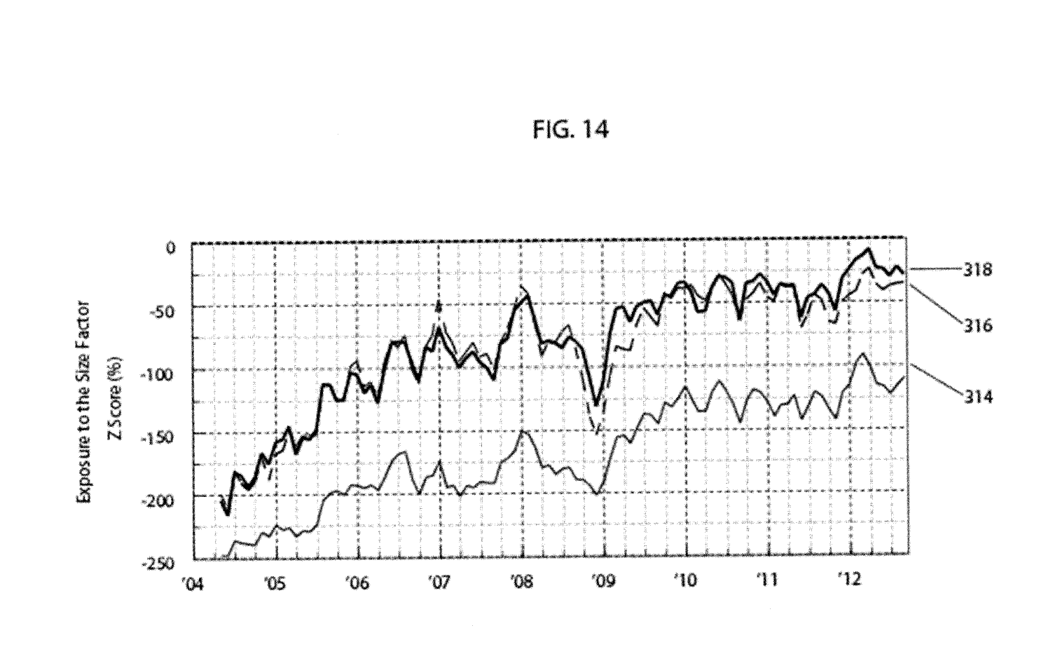

FIG. 14 shows the exposure of the three low volatility portfolios to the size factor. The size factor in a factor risk model is a Z score value representing the natural logarithm of the market capitalization of each asset. The non-target exposure constraints in both optimizations have a dramatic effect for the size factor exposure. The size exposure of the reference portfolio 314 is generally about 75% lower (a substantial small cap biased, representing a non-pure exposure relative to volatility) than the exposure of the two optimized portfolios, the traditional optimization portfolio 316 and the constrained optimization portfolio 318.

These two backtests illustrate cases in which target factor portfolios that have been purified using orthogonalized non-target factors outperform those purified using raw non-target factors as well as the simple reference portfolio. It is anticipated that portfolio managers will prefer to be able to automatically impose orthogonalized, non-target factor constraints as a standard feature in a portfolio optimization tool.

Although the present invention is different than the prior art, it possesses similarities to existing techniques used for portfolio construction using optimization. U.S. Pat. No. 7,698,202 describes a technique in which a factor risk model is augmented by additional risk associated with the vector that is the projection of the asset holdings into the null space of the set of factor risk model factors. That is, the additional risk is related to the orthogonal projection of the holdings. This patent is incorporated by reference herein in its entirety. In this procedure, there is no need for a target factor. The document “Refining Portfolio Construction When Alphas and Risk Factors are Misaligned” by J. Bender, J.-H. Lee, and D. Stefek, MSCI Barra Research Insight, March 2009, available at http://www.mscibarra.com/research/articles/2009/RI_Refining_Port_Construction.pdf describes a technique in which the objective function of a portfolio optimization problem is modified by a penalty associated with the vector that is the projection of the “alpha” vector, which is the vector of expected returns or, equivalently, the target factor into the null space of the set of factor risk model factors. That is, the objective function penalty is the orthogonal projection of the target factor. This document is incorporated by reference herein in its entirety.

Like the present invention, both of these techniques describe an orthogonal projection. However, the orthogonal projection in these two techniques is different than that described in the present invention. For these two techniques, the orthogonal projection is the projection into the null space of a set of factors used by a factor risk model. Specifically, let X be the matrix of factor exposures in a factor risk model (see U.S. Pat. No. 7,698,202 and Litterman for details). Then, the projection operator used by the prior art techniques is

P_{RM}=I−X(X^{T}X)⁻¹X^{T} (6)

where I is the identity matrix and the inverse may be a pseudo-inverse if necessary. In the technique described in U.S. Pat. No. 7,698,202, the additional variance added to the predicted risk model variance is proportional to

σ_{RM}²=c²w^{T}P_{RM}^{w} (7)

for some constant c. For the technique described by Bender et al., the penalty in the objective function is proportional the

U=θ²α^{T}P_{RM}α (8)

for some constant θ, where α is the alpha vector, which is equivalent to the target vector in the present invention.

In the present invention, the orthogonal projection is with respect to the target vector, not a set of risk model factors. Formally, we can compute this projection as

Pⱼ=I−f(f^{T}f)⁻¹f^{T} (9)

which, because the target factor f is one dimensional, reduces to the formula given in equation (3).

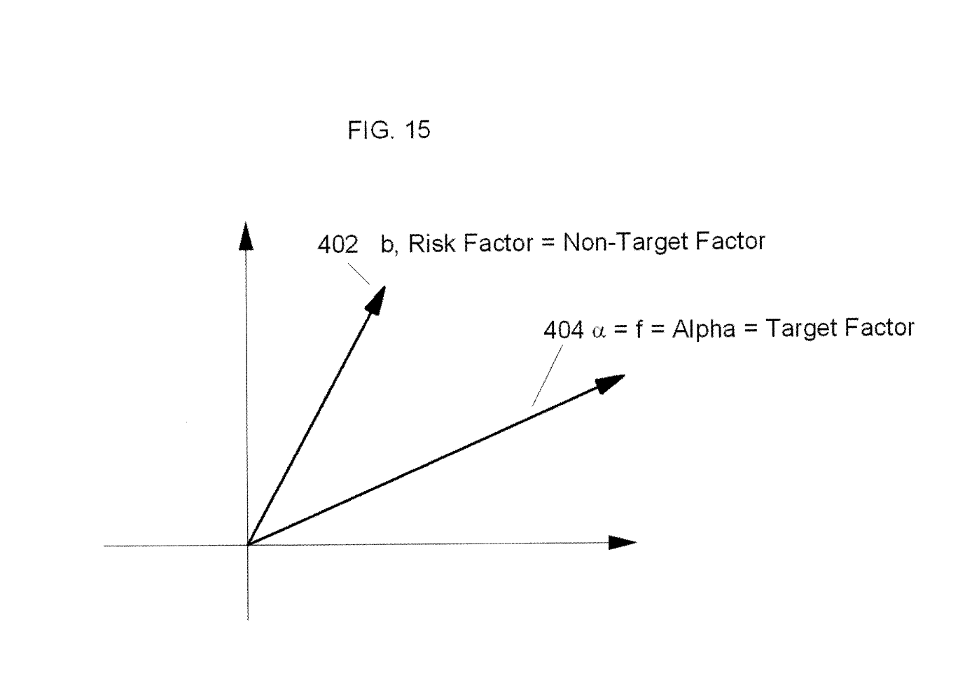

FIGS. 15, 16, and 17 provide a further illustration of the difference of the present invention from the prior art. In FIG. 15, there is a single non-target factor 402 and a target factor 404, both of which are two dimensional for illustration purposes of the example. The non-target factor 402 may be a factor from a factor risk model in which case it could be termed a risk factor. The symbol b is used to indicate this factor. The target factor 404 may be the alpha signal or expected return. In mean-variance optimization, the expected return of the optimal portfolio is maximized. Alternatively, the exposure of the optimal portfolio to the target factor can be minimized, as it was in for the two backtests described herein for which the target factor was volatility. The symbol α is used to indicate this target factor.

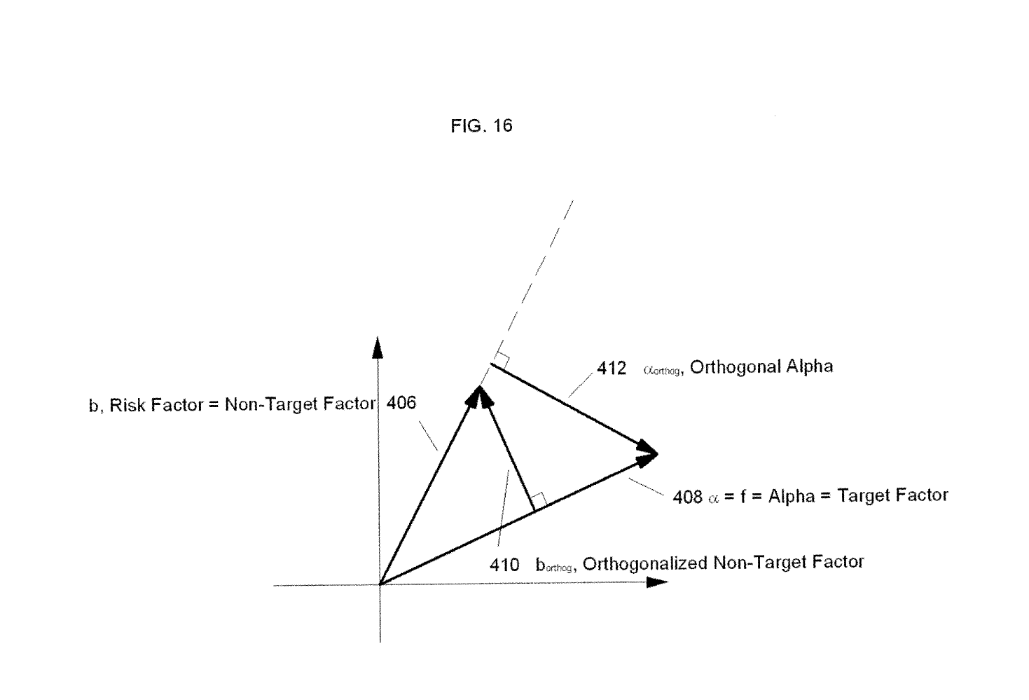

In FIG. 16, we have the same non-target factor 406 and the same target factor 408. In addition, we show two different projections. The orthogonalized non-target factor 410, computed as b_{arthog}=P_{f}b, is perpendicular to the target factor. In this example, it points to the upper left of FIG. 16. The orthogonal alpha, computed as α_{orthog}=P_{RM}α and used in the work of Bender et al., is perpendicular to the non-target factor and points to the bottom right. As can be readily seen in FIG. 16, these two vectors are not parallel. As a result, the changes they make to the optimization are not identical, and the present invention is therefore different than the prior art.

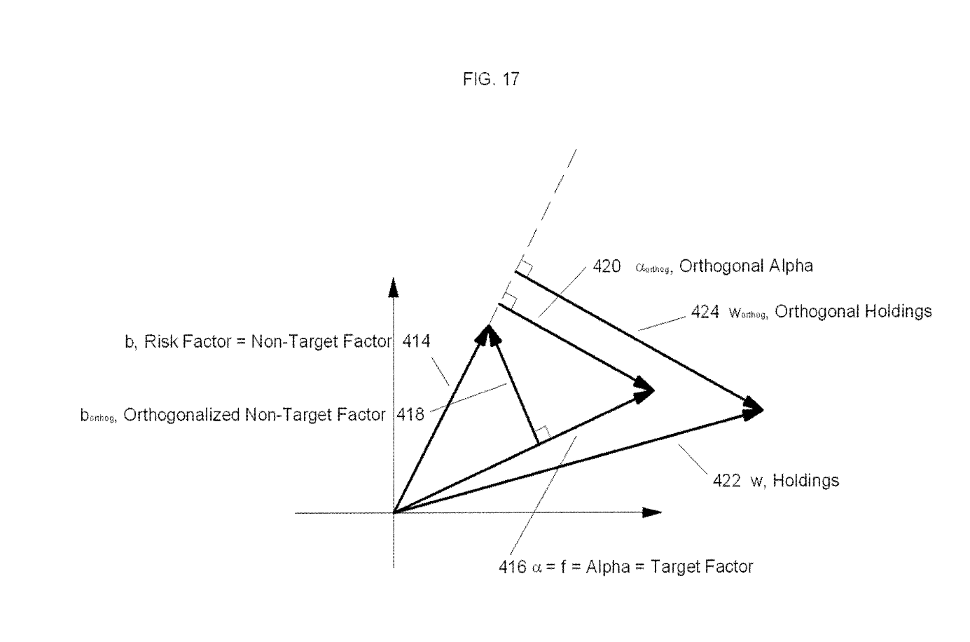

In FIG. 17, we take the same example and add a set of holdings 422, denoted by w. The target factor 416 is the same; the non-target factor 414 is the same; the orthogonalized non-target factor 418 is the same; and the orthogonal alpha 420 is the same. In order to illustrate the method of U.S. Pat. No. 7,698,202, we have added the set of holdings 422. risk imposed in U.S. Pat. No. 7,698,202. The important thing to notice is that the orthogonal alpha 420 and the orthogonal holdings 424 are parallel in this simple example. As a result, their impact on the optimal holdings is parameterized by the same vector direction. This is a different direction than the direction considered in the present invention, the orthogonalized non-target factor 418.

For the present invention, the impact of the orthogonalized constraint is to limit exposures that are orthogonal to the target vector. In this method, these orthogonal exposures are considered unintended bets and reduced and limited by the optimization. Unlike the prior art, the present invention does not limit the holdings in the direction defined by the target factor. The directions associated with the prior art can posses a non-zero component that aligns with the target factor and can therefore reduce the exposure of the optimal holdings in that direction. In fact, the paper “Do Risk Factors Eat Alphas?” by J.-H. Lee and D. Stefek, MSCI Barra Research Insight, April 2008, available at http://www.mscibarra.com/products/analytics/aegis/RI_Do_Risk_Models_Eat_Alphas_April_{—}08.pdf, incorporated by reference herein in its entirety, indicates that having constraints that overlap with alpha do degrade performance. The present invention explicitly ensures that the orthogonal constraints do not degrade alpha or performance.

In many optimizations, the direction of implied alpha can be different than the target factor. If we denote the asset-asset covariance matrix as Q, then the implied alpha is given by

αᵢ=cQw (10)

where w represent the optimal holdings and c is a non-zero constant to be determined depending on how α₁ is to be normalized. The asset-asset covariance matrix can be derived from a factor risk model. The implied alpha is the expected return that would give the optimal holdings as the most simple mean-variance optimization problem. When the implied alpha and the target factor are not well aligned, this indicates that constraints imposed in the optimization problem have substantially affected the optimal solution.

A natural extension of the present invention is to apply it to the orthogonal projection of the implied non-target factor. One way to extend the present invention to consider implied alpha is to alter equation (3) to include risk-adjusted constraints

$${B}_{( j )}^{′} = {QB}_{( j )} - ( \frac{{f}^{T} ( {QB}_{( j )} )}{{f}^{T} f} ) f , \\ j = 1 , … , M \qquad ( 11 )$$

Such risk-adjusted constraint can also improve portfolio performance. Alternatively, one can formally create the null projection matrix of Qw instead off and then use that as the target factor to alter the constraints. An optimization problem that simultaneously solves for the optimal holdings with orthogonalized constraints based on Qw instead off can also improve portfolio performance.

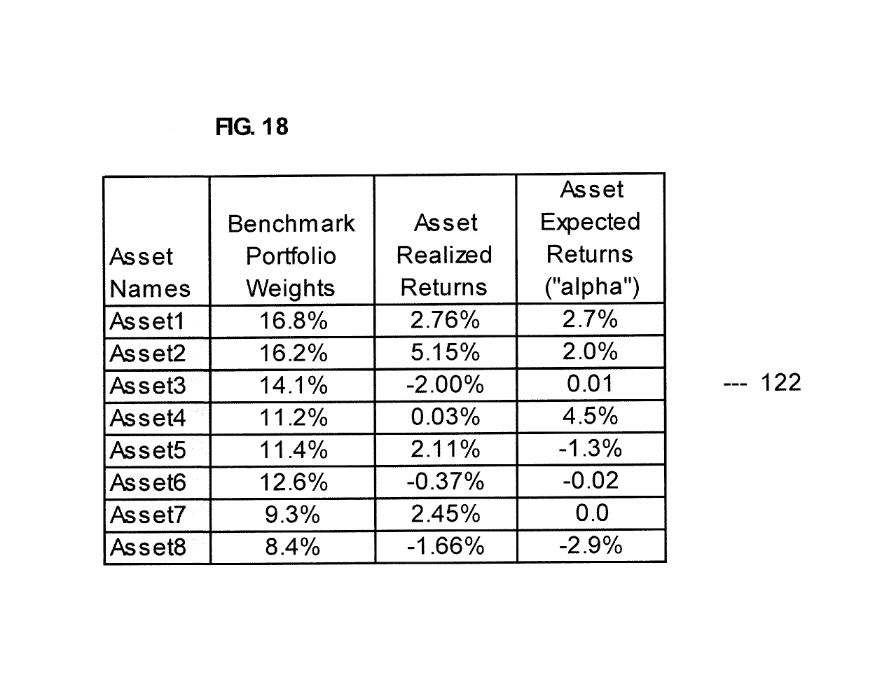

A simple, detailed, numerically worked out example is presented to illustrate the aspects of the invention. Consider a universe of eight assets identified as Asset1, Asset2, Asset2, Asset3, Asset4, Asset5, Assct6, Asset7, and Asset8. FIG. 18 shows a table 122 with benchmark weights, realized (e.g., actual) returns, and expected returns (“alpha” or α) for this universe of eight assets. The assets are ordered in terms of decreasing benchmark weight. The sum of the benchmark weights is 100%.

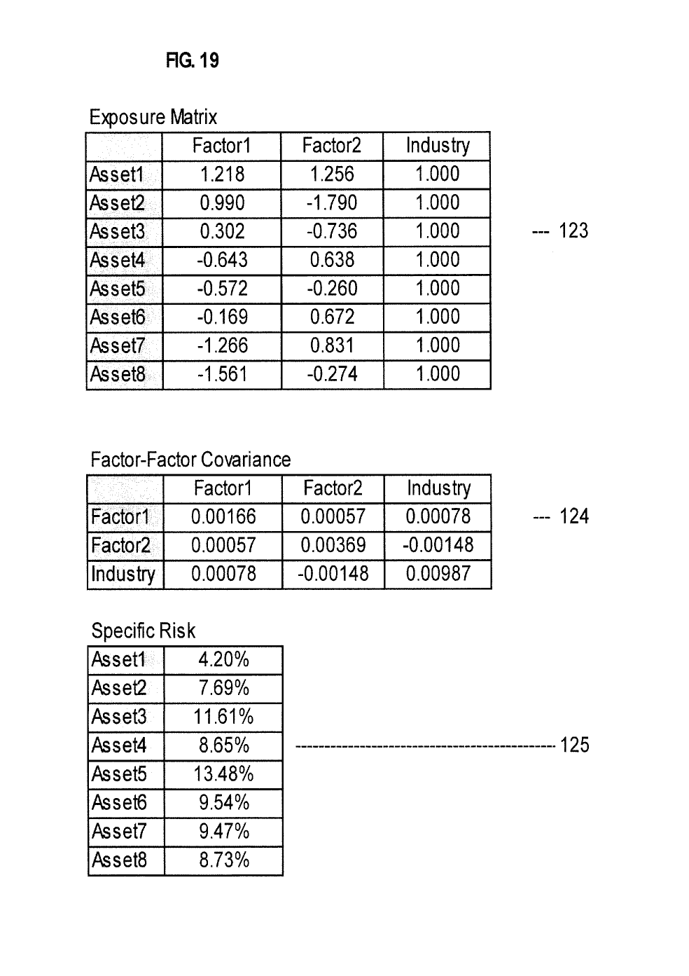

For this universe, a factor risk model comprising a matrix of factor exposures, denoted X, a matrix of factor-factor covariances, denoted S, and a vector of specific risks, denoted as D, is employed. FIG. 19 shows tables with the matrix of factor exposures 123, the matrix of factor-factor covariances 124, and the vector of specific risks 125 for the universe of eight assets.

The asset-asset covariance matrix for this universe is computed using matrix algebra by the formula

Q=XSX^{T}+diag(D²) (12)

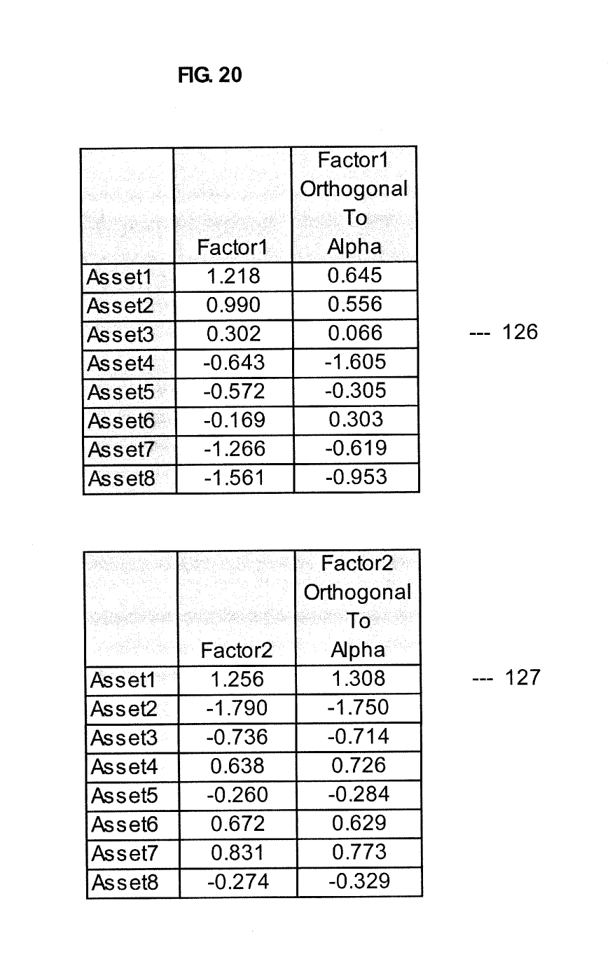

The factor risk model has three factors, Factor1, Factor2, and Industry. For this example, Factor1 and Factor2 are considered to be non-target factors. The target factor is the expected return (e.g., “alpha” 122) shown in FIG. 18. FIG. 20 shows the non-target factor exposures Factor1 126 and Factor2 127 as well as the orthogonalized, non-target factors for Factor1 and Factor2. From these results, it is seen that orthogonalizing Factor1 with respect to alpha alters its components substantially, whereas the changes in Factor2 after orthogonalization are more modest.

For this simple example, three optimal portfolios are computed.

First, an optimized portfolio is computed with no constraints on either Factor1 or Factor2. Mathematically, we define this optimization problem as:

Maximize

α^{T}w (13)

subject to:

w₁+w₂+w₃+w₄+w₅+w₆+w₇+w₈=100% (14)

0%≦wᵢ≦100%, i=1, . . . , 8 (15)

(w−w_{b})^{T}Q(w−w_{b})≦2% (16)

Utilizing equation 13, the optimizer maximizes the portfolio's exposure to “alpha”, the expected return or target factor for this problem. Equation 14 indicates that the investment allocation uses all the funds available and is fully invested. Equation 15 indicates that the holdings in each of the eight assets must be positive (e.g., no shorting) and can be at most 100%. Equation 16 indicates that the tracking error or active risk in the final, optimized portfolio can be at most 2%. In this formula, w is used to indicate the optimized portfolio and w_{b} to indicate the benchmark portfolio defined in FIG. 18. This optimization problem is a standard mean-variance optimization problem used for portfolio construction.

The second optimized portfolio is computed using the same conditions shown in equations 13, 14, 15, and 16 plus two additional constraints on the active exposures of the optimized portfolio to Factor1 and Factor2. These are denoted mathematically as

−10%≦f₁^{T}(w−w_{b})≦10% (17)

−10%≦f₂^{T}(w−w_{b})≦10% (18)

where f₁ and f₂ are the exposure to Factor1 and Factor2 respectively. These two column vectors are shown in FIG. 20 under the headers Factor1 and Factor2, e.g., the center column in the tables. These two additional constraints ensure that the exposure of the optimized portfolio to Factor1 and Factor2 differs from the benchmark by no more than ten percent.

For the third optimization problem, the constraints shown in equations 17 and 18 are replaced by constraints on the orthogonalized exposures to Factor1 and Factor2. That is

−10%≦g₁^{T}(w−w_{b})≦10% (19)

−10%≦g₂^{T}(w−w_{b})≦10% (20)

where g₁ and g₂ are the orthogonal exposures to Factor1 and Factor2 respectively. These two column vectors are shown in FIG. 20 under the headers “Factor1 Orthogonal to Alpha” and “Factor2 Orthogonal to Alpha”, e.g., the right hand column in the tables.

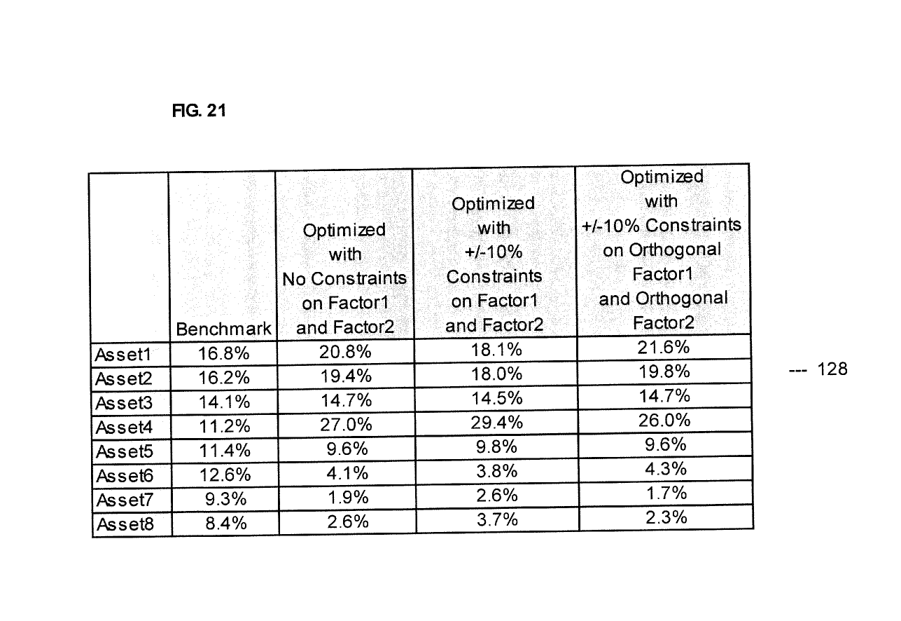

All three optimization problems were solved using Axioma's portfolio construction software Axioma Portfolio™. The benchmark and optimal portfolio weights are shown in the table 128 in FIG. 21. Notice that the portfolio allocations in all three optimal portfolios are similar. The addition of the exposure and orthogonal exposure constraints leads to relatively modest changes in the optimal portfolio allocations in this particular example. For all four portfolios shown in table 128, the sum of the portfolio allocations across all eight assets adds up to 100%.

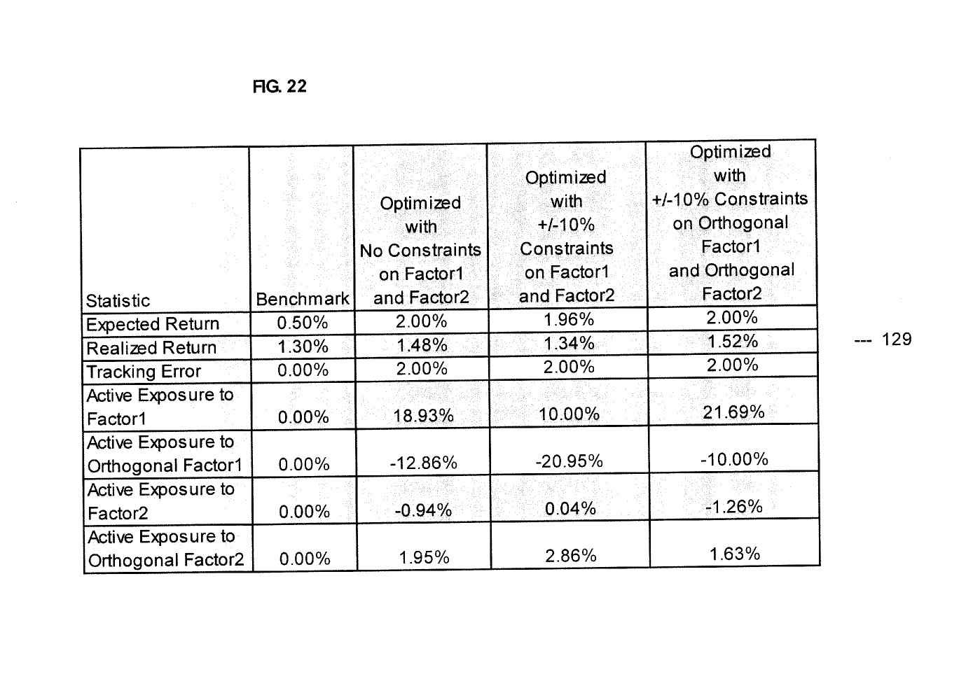

The table 129 in FIG. 22 shows several descriptive statistics for the four portfolios shown in 128. The expected return for the three optimized portfolios based on alpha is larger than the expected return of the benchmark. This result is to be expected as the optimization has maximized this statistic. In terms of realized returns, all three optimized portfolios outperform the return of the benchmark. The benchmark has a realized return of 1.30%; the optimized portfolio with no exposure constraints has a realized return of 1.48%; the optimized portfolio with exposure constraints on Factor1 and Factor2 has a realized return of 1.34%, just barely out-performing the benchmark; and the optimized portfolio with orthogonal exposure constraints on Factor1 and Factor2 has a realized return of 1.52%, the best of all four portfolios.

Table 129 shows that when no exposure constraints are enforced (the first optimized portfolio), the optimized portfolio has an active exposure of +18.93% to Factor1 and −0.94% to Factor2. This active exposure represents a substantial exposure to Factor1, indicating that this portfolio is non-neutral or non-pure with respect to this factor.

When the constraints on the active exposures to Factor1 and Factor2 are applied (second optimized portfolio), the exposure to Factor1 is reduced to 10%, improving the purity of the portfolio at the expense of a reduction both in the expected return and the realized return.

When the constraints on the active, orthogonal exposures to Factor1 and Factor 2 are applied (third optimized portfolio), the constraint to orthogonal Factor1 is active and set at −10%. But the realized return increases in this case.

For all three optimization problems, the active exposure to Factor2 and the orthogonal Factor2 is within plus and minus 10%. The constraints shown in equations 18 and 20 are satisfied but inactive, so they do not affect the optimal solution in this particular case.

While the present invention has been disclosed in the context of various aspects of presently preferred embodiments, it will be recognized that the invention may be suitably applied to other environments consistent with the claims which follow.

I claim:

1. A computer-implemented method of constructing a portfolio comprising:
electronically receiving by a programmed computer a set of N potential investments;
electronically receiving by the programmed computer an N-dimensional vector of target factor scores for each of the possible investments;
electronically receiving and storing by the programmed computer a set of one or more N-dimensional vectors of non-target factors scores;
electronically receiving and storing by the programmed computer an optimization problem for determining an N-dimensional vector of investment allocations that includes upper and lower bound constraints on the exposures to the non-factor scores;
determining projections of the non-factor scores that are orthogonal to the target factor;
computing an optimal investment allocation vector for the optimization problem where the upper and lower bound constraints for the exposures to the non-factor scores are computed using the projections of the non-factor scores that are orthogonal to the target factor; and
electronically outputting the optimal investment allocation vector using an output device.

2. The method of claim 1 in which the non-target factor scores are factors from a factor risk model.

3. The method of claim 1 in which the optimization problem either maximizes or minimizes the exposure of the optimal investment allocation vector to the target factor.

4. The method of claim 1 in which the optimized portfolios are determined at distinct historical times to simulate the performance of the optimized portfolio over time.

5. The method of claim 1 in which the target factor is an implied alpha of a portfolio.

6. A computer-based method of constructing a purified factor portfolio comprising:
electronically receiving and storing by a programmed computer a set of N potential investments;
electronically receiving and storing by a programmed computer an N-dimensional vector representing the relative market capitalization of each possible investment;
electronically receiving and storing by the programmed computer an N-dimensional vector of target factor scores for each of the possible investments;
determining a reference portfolio for the target factor by defining the reference portfolio investment allocation using the factor scores and market capitalization of each potential investment;
electronically receiving and storing by the programmed computer a set of one or more N-dimensional vectors of non-target factors scores;
determining a projection of the non-factor scores that is orthogonal to the target factor;
electronically receiving and storing by the programmed computer a factor risk model that predicts future volatility for the N possible investments;
computing an optimal investment allocation vector that simultaneously minimizes the predicted tracking error between the optimal allocation and the reference portfolio while minimizing the absolute active exposure of the portfolio to the orthogonal non-factor scores; and
electronically outputting the optimal investment allocation vector using an output device.

7. The method of claim 6 in which the non-target factor scores are factors from a factor risk model.

8. The method of claim 6 in which the optimized portfolios are determined at distinct historical times to simulate the performance of the optimized portfolio over time.

9. The method of claim 6 in which the target factor is an implied alpha of a portfolio.

10. A computer implemented system for constructing a purified factor portfolio, the system comprising:
a memory for storing data for a set of N potential investments;
a processor executing software to retrieve data for an N-dimensional vector representing the relative market capitalization of each potential investment;
a processor executing software to retrieve data for an N-dimensional vector of target factor scores for each of the potential investments;
computing on the processor executing software a reference portfolio for the target factor by defining the reference portfolio investment allocation using the factor scores and market capitalization of each potential investment;
a processor executing software to retrieve data for a set of one or more N-dimensional vectors of non-target factors scores;
computing on the processor executing software a projection of the non-factor scores that is orthogonal to the target factor;
a processor executing software to retrieve data for a factor risk model that predicts future volatility for the N potential investments;
computing on the processor executing software an optimal investment allocation vector that simultaneously minimizes the predicted tracking error between the optimal allocation and the reference portfolio while minimizing the absolute active exposure of the portfolio to the orthogonal non-factor scores; and
computing on the processor an electronic output representing the optimal investment allocation vector.

11. The computer implemented system of claim 10 in which the non-target factor scores are factors from a factor risk model.

12. The computer implemented system of claim 10 in which the optimized portfolios are determined at distinct historical times to simulate the performance of the optimized portfolio over time.

13. The computer implemented system of claim 10 in which the target factor is an implied alpha of a portfolio.
